(19) United States
(12) Patent Application Publication
(10) Pub. No.: US 2016/0055175 A1
(43) Pub. Date: Feb. 25, 2016

(54) GEOGRAPHIC SEARCH SYSTEM

(71) Applicants: JAN THOMPSON, EDINBURGH (GB); PAUL THOMPSON, EDINBURGH (GB)

(72) Inventors: JAN THOMPSON, EDINBURGH (GB); PAUL THOMPSON, EDINBURGH (GB)

(73) Assignee: TELECOMMUNICATION SYSTEMS, INC., ANNAPOLIS, MD (US)

(21) Appl. No.: 14/521,218

(22) Filed: Oct. 22, 2014

Related U.S. Application Data
(60) Provisional application No. 62/041,461, filed on Aug. 25, 2014.

(51) Int. Cl. G06F 17/30; G06F 3/0482; G06F 3/0484; H04L 29/08

(52) U.S. Cl. CPC G06F 17/30241; G06F 17/3087; G06F 17/30554; H04L 67/18; G06F 3/0482; G06F 3/04842

(57) ABSTRACT

One example includes a method for implementing a geographic search. The method includes receiving search data from a plurality of mobile search stations. The search data being associated with a geographic search area corresponding to a contiguous geographic area through which a respective one of the plurality of mobile search stations has traversed over time. The method also includes aggregating the geographic search area associated with the search data provided from each of the plurality of mobile search stations to generate an aggregate geographic search area. The method also includes displaying a map of a geographic region on a monitor. The method further includes superimposing a geographic location of each of the mobile search stations and the aggregate geographic search area on the map of the geographic region.

### CROSS-REFERENCE TO RELATED APPLICATION

This application claims the benefit of priority to U.S. Provisional Application No. 62/041,461 filed on Aug. 25, 2014, and entitled SEARCH AND RESCUE/RECOVERY USING ‘FOLLOW ME’ TECHNIQUES, the entirety of which is herein incorporated by reference.

### TECHNICAL FIELD

This disclosure relates to a geographic search system.

### BACKGROUND

Emergency search and rescue tactics have been implemented for a number of different purposes, such as to search and rescue missing hikers, missing or abducted children or adults, for forensic investigations, and/or for law enforcement. In such search and rescue procedures, people are typically deployed to search areas of a geographic region. Such deployment can be organized, such as in a grid or pattern, such that people are assigned to different portions of the geographic region to cover as great an area and with as great of detail of searching as possible. Such search efforts can require a lot of communication as to ground covered in the geographic region, time of regrouping of people involved in the search or of changing of shifts of the searching parties, and organization of the search efforts.

### SUMMARY

One example includes a method for implementing a geographic search. The method includes receiving search data from a plurality of mobile search stations. The search data being associated with a geographic search area corresponding to a contiguous geographic area through which a respective one of the plurality of mobile search stations has traversed over time. The method also includes aggregating the geographic search area associated with the search data provided from each of the plurality of mobile search stations to generate an aggregate geographic search area. The method also includes displaying a map of a geographic region on a monitor. The method further includes superimposing a geographic location of each of the mobile search stations and the aggregate geographic search area on the map of the geographic region.

Another example includes a method for implementing a geographic search. The method includes receiving search commands provided by a controller station via a network and providing navigation instructions in response to the search commands. The method also includes generating search data associated with a geographic search area corresponding to a contiguous geographic area that is defined by a geographically-traversed distance over time. The method further includes transmitting the search data via the network to the controller station.

Another example includes a geographic search system. The system includes one or more mobile search stations that are each configured to generate search data associated with a geographic search area corresponding to a contiguous geographic area through which a respective one of the one or more mobile search stations has traversed over time. The system also includes a controller station comprising a monitor configured to display a map of a geographic region. The controller station is configured to receive the search data from each of the one or more mobile search stations via a network and to superimpose a physical location and the geographic search area associated with each of the one or more mobile search stations on the map of the geographic region.

### BRIEF DESCRIPTION OF THE DRAWINGS

FIG. 1 illustrates an example of a geographic search system.

FIG. 2 illustrates an example of a mobile search station.

FIG. 3 illustrates another example of a mobile search station.

FIG. 4 illustrates an example of a controller station.

FIG. 5 illustrates another example of a controller station.

FIG. 6 illustrates an example of a method for implementing a geographic search.

FIG. 7 illustrates another example of a method for implementing a geographic search.

### DETAILED DESCRIPTION

This disclosure relates to a geographic search system. The geographic search system can be implemented in any of a variety of environments for a variety of search and rescue applications. For example, the geographic search system can be implemented in Amber Alerts for missing persons or children, for forensic investigations, for missing hikers/campers in a wilderness setting, or for any of a variety of other applications. The geographic search system implements a controller station and a plurality of mobile search stations. Each of the plurality of mobile search stations can be implemented as persons carrying or operating a wireless electronic device, such as a smart-phone, a laptop computer, a tablet computer, a vehicle mounted computer system, or a variety of other mobile computer devices. The controller station can correspond to a fixed computer, a mobile computer device, or an enterprise computer system. As an example, the mobile search stations can implement an application software program (e.g., an “App”) that can communicate with the controller station to provide search and rescue capability. Additionally, the application software program can interface with the navigation software and/or location-based services of the wireless electronic device corresponding to the mobile search station to implement the search and rescue capability.

The mobile search stations can be configured to generate search data associated with a geographic search area corresponding to a contiguous geographic area through which the mobile search stations have traversed over time. The search data of each of the mobile search stations can be transmitted to the controller station. As a result, the controller station can be configured to aggregate the search data to generate an aggregate geographic search area corresponding to all of the geographic areas searched by all of the mobile search stations. The aggregate search area can be superimposed on a map of a geographic region that is displayed on a monitor that can also show the real-time location of the mobile search stations. Therefore, the controller station can track all of the areas in the geographic region that have been searched to provide a more efficient search based on mitigating redundancy in the search efforts of disparate parties.

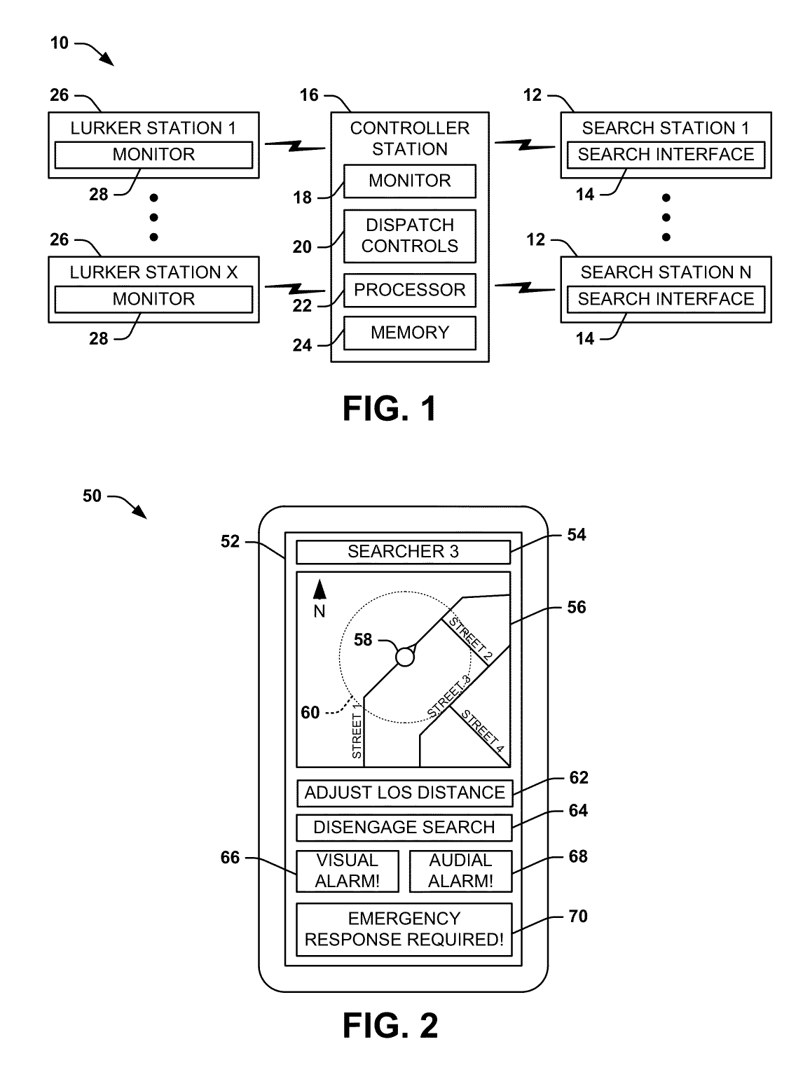

FIG. 1 illustrates an example of a geographic search system 10. The networked geographic search system 10 can be implemented in a variety of search and rescue applications in which multiple searching parties can coordinate search efforts. For example, the geographic search system 10 can be implemented for search and rescue missing hikers, missing or abducted children or adults, aquatic search and rescue, for forensic investigations, and/or for law enforcement applications.

The geographic search system 10 includes a plurality N of mobile search stations 12, where N is a positive integer. The mobile search stations 12 can correspond to any of a variety of wireless electronic devices that are mobile, such as a smart-phone, a laptop computer, a tablet computer, a vehicle-mounted computer system, or a variety of other mobile computer devices. In the example of FIG. 1, each of the mobile search stations 12 includes a search interface 14 that can correspond to software operating on the mobile search stations 12 that allow the mobile search stations 12 to provide the geographic search capability via a wireless network, as described herein. The search interface 14 can include prompts for inputs from the respective user, as well as transparent functionality that interacts with navigation software and/or location-based services associated with the mobile search stations 12. As an example, the mobile search stations 12 can implement the search interface 14 as an application software program (e.g., an “App”) that can be downloaded to the respective mobile search stations 12 and executed to provide the geographic search capability. For example, the application software program can interface with existing separate navigation software and/or location-based services of the wireless electronic device corresponding to the respective mobile search station 12 to implement the geographic search capability.

The geographic search system 10 also includes a controller station 16 that is configured to communicate with the mobile search stations 12 via the wireless network to coordinate the search effort. As an example, the wireless network can correspond to a local-area network (LAN) or a wide-area network (WAN), such as a cellular network, to provide wireless communication between the controller station 16 and the mobile search stations 12. The network could be implemented as a public network (e.g., the Internet), a private network, an ad-hoc network, or a combination thereof. As another example, in a geographic environment that may be prohibitive of using existing network (e.g., cellular) topology, such as in an aquatic environment or in a wilderness environment, the geographic search system 10 can incorporate a flying drone to act as a wireless network base-station to allow communication between the mobile search stations 12 and the controller station 16 over large geographic distances.

As an example, the controller station 16 is configured as a computer that can be a fixed computer terminal or a mobile computer (e.g., a laptop computer, tablet computer, or a smart-phone). The controller station 16 includes a monitor 18, dispatch controls 20, a processor 22, and memory 24. The monitor 18 is configured to display a map of a geographic region in which a search is being conducted by the mobile search stations 12. The controller station 16 can thus be configured to superimpose a real-time geographic location of the mobile search stations 12 on the map of the geographic region that is displayed on the monitor 18, as well as an aggregate geographic search area associated with all of the mobile search stations 12, as described in greater detail herein. Thus, the controller station 16 can control and coordinate the search effort among the mobile search stations 12 to provide an efficient search with respect to communication with the mobile search stations 12 and to mitigate redundant searching of the geographic region of a given one of the mobile search stations 12 with respect to other mobile search stations 12.

The controller station 16 can be configured to selectively register and de-register each of the mobile search stations 12 to provide the geographic search function, as described herein. As an example, the mobile search stations 12 with the search interface 14 can be “bumped” with the controller station 16 or other mobile search stations within the group, such that the respective mobile search stations 12 can be registered with the controller station 16 via near field communications (NFC). In other examples, the controller station 16 can be configured to display a Quick Response (QR) code with a geographic search code embedded therein. In other examples, the geographic search code can be disseminated to the mobile search stations 12 upon actuation of a “share” virtual button at the controller station 16, such as by email, short message service (SMS) message, a Session Initiation Protocol (SIP) message, Extensible Messaging and Presence Protocol (XMPP), verbal or written communication, etc. As a further example, the controller station 16 can selectively register the mobile search stations 12 via contact information (e.g., phone numbers, log-in data, Internet Protocol (IP) or Media Access Control (MAC) addresses, etc.). As yet another example, the search interface 14 of the mobile search stations 12 can include capability to register or de-register the respective mobile search stations 12 in the search effort, such as after an initial registration with the controller station 16 or as a request to join an existing search. Similarly, the controller station 16 can be configured to contact a given one of the mobile search stations 12 to register or re-register the mobile search stations 12 in the search effort, or to contact a wireless electronic device as a request to join the search effort.

The dispatch controls 20 of the controller station 16 are configured to provide communication to the mobile search stations 12. The communication can be provided in a variety of different forms, such as in a broadcast transmission (i.e., to all of the mobile search stations 12), a multicast transmission (i.e., to some of the mobile search stations 12), or a unicast transmission (i.e., to individual ones of the mobile search stations 12) of voice, text, or image data. The dispatch controls 20 can also be configured to provide search commands to the mobile search stations 12, individually or collectively, to provide instructions to the mobile search stations 12 as to where to conduct the search within the geographic region.

As an example, a user at the controller station 16 can interact with the map being displayed on the monitor 18 to set locations, routes, directions, and/or regions for the mobile search stations 12 to search as the search commands. The search commands can then be sent to the mobile search stations 12, such that navigation software of the respective mobile search stations 12 can provide navigation assistance to the corresponding users to travel to the locations, routes, and/or regions designated by the controller station 16 via the dispatch controls 20. Thus, in response to the search command received at a given one of the mobile search stations 12, the navigation software of the respective mobile search stations 12 can generate a route or re-route to a designated spot or search area. As yet another example, the search interface 14 of the mobile search stations 12 can implement a “Follow-Me” application software based on the search commands provided by the controller station 16. For example, the controller station 16 can likewise be mobile, such that the controller station 16 can provide “Follow Me” navigation commands to allow the mobile search stations 12 to follow the controller station 16, and can thus designate search commands to the mobile search stations 12 to allow the mobile search stations 12 to break-away from following the controller station 16 to branch-off and search separate portions of the geographic region.

The search interface 14 of each of the mobile search stations 12 can be configured to implement a location of the respective one of the mobile search stations 12 to generate search data (e.g., via a processor) and to transmit the search data to the controller station 16. As an example, the search data can be generated based on at least one of a navigation system (e.g., implementing navigation software) and location-based services of the wireless electronic device associated with each of the respective mobile search stations 12. As described herein, the term “navigation software” corresponds to a satellite navigation system designed to assist in navigation while traversing the geographic region, such as while walking or operating a vehicle (e.g., an automobile, watercraft, or aircraft). The navigation software can be integrated with a wireless electronic device, such as a smartphone or a tablet computer, or can be vehicle-mounted.

A given navigation system can employ a global navigation satellite system (GNSS), such as a global positioning satellite (GPS) navigation device, to acquire position data to locate a user on a road or trail in a map database stored in or with the navigation system. By employing the map database, the navigation system can provide directions to other locations along roads or trails that are also in the map database. In some examples, the navigation system can implement dead-reckoning techniques that employ distance data from sensors attached to a drivetrain of the vehicle, a gyroscope and/or an accelerometer integrated with the navigation system to improve reliability, as GPS signal loss and/or multipath can occur due to obstructions, such as canyons, buildings or tunnels. Additionally, the location-based services of the respective wireless electronic device corresponding to one or more of the mobile search stations 12 can be implemented to generate the search data. As an example, the location-based services can implement the GPS location of the respective mobile search stations 12, can implement “check-in” location inputs, registration with cellular base stations or Wi-Fi hot-spots, or a combination thereof.

The search data can be associated with a geographic search area within the geographic region, with the geographic search area corresponding to a contiguous geographic area through which a respective one of the mobile search stations 12 has traversed over time. Therefore, the geographic search area can correspond to a time-based histogram of the portions of the geographic region that a given mobile search stations 12 has searched. As an example, the search data generated by a given one of the mobile search stations 12 can correspond to a real-time geographic location of a mobile search station 12 that is periodically transmitted to the controller station 16, such that the controller station 16 can be configured to ascertain the geographic search area of the mobile search station 12 based on a histogram of the periodically transmitted real-time geographic location of the mobile search station 12. As another example, the mobile search station 12 can be configured to generate a histogram of the geographic location traversed by the mobile search station 12 over time, such as via navigation software that is implemented by the mobile search station 12, such that the mobile search station 12 can transmit the geographic search area that is generated by the mobile search station 12 to the controller station 16.

The controller station 16 can thus receive the search data transmitted via the network from each of the mobile search stations 12. The search data associated with each of the mobile search stations 12 can be stored in the memory 24 and can be aggregated via the processor 22 to generate aggregate search data. The aggregate search data can thus correspond to the geographic search area associated with all of the mobile search stations 12 involved in the search effort, and can thus provide a record of all portions of the geographic region that have been searched over time since the initialization of the search effort. The processor 22 can then superimpose the aggregate geographic search area over the image of the geographic region that is displayed on the monitor 18. Thus, the monitor 18 can display the map of the geographic region with an indication of all of the portions that have been searched since the initialization of the search effort. As a result, the controller station 16 can control and coordinate the search effort among the mobile search stations 12 to provide an efficient search with respect to communication with the mobile search stations 12 and to mitigate redundant searching of the geographic region of a given one of the mobile search stations 12 with respect to other mobile search stations 12. For example, a user at the controller station 16 can implement the dispatch controls 20 to selectively direct the mobile search stations 12 to the unsearched portions of the geographic region.

In addition, the geographic search system 10 can include a plurality X of lurker stations 26, where X is a positive integer, that are communicatively coupled to the controller station 16. As an example, the lurker stations 26 can be configured substantially similar to the controller station 16. In the example of FIG. 1, the lurker stations 26 each include a monitor 28, such that a user of each of the respective lurker stations 26 can view a map of the geographic region that can likewise be displayed on the monitor 18 of the controller station 16. As an example, the controller station 16 can be configured to transmit the map of the geographic region with the superimposed positions of the mobile search stations 12 and the aggregate geographic search region to each of the lurker stations 26 for display on the respective monitors 28. Therefore, the lurker stations 26 can be configured as passive stations for monitoring the given search effort.

As an example, one or more of the lurker stations 26 can be configured to have no control, and thus can be absent the dispatch controls 20. As another example, the lurker stations 26 can each have control capability, such that control of the search effort can be passed to a given one of the lurker stations 26 by the current controller station 16. As a result, the lurker station 26 can be configured as a new controller station 16, and functionality of the previous controller station 16 can be switched to a lurker station 26. Such function passing can be based on request, password protected, or other functional relationship, and can occur as a result of a shift change or other circumstance. Additionally, one or more of the lurker stations 26 can also be configured to provide search capability, such that the lurker stations 26 can also be activated to become one of the mobile search stations 12. Therefore, the controller station 16 can be configured to pass control of the search effort to a given one of the mobile search stations 12, as well as one of the lurker stations 26.

FIG. 2 illustrates an example of a mobile search station 50. The mobile search station 50 is demonstrated in the example of FIG. 2 as a wireless electronic device, such as a smart-phone or a tablet computer. The mobile search station 50 can be configured as one of the mobile search stations 12 in the example of FIG. 1. Therefore, reference is to be made to the example of FIG. 1 in the following description of the example of FIG. 2.

The mobile search station 50 can be operating a search interface 14 (e.g., the search interface 14 in the example of FIG. 1) that can be configured as an application software program (i.e., “App”) to provide the search capability in the example of FIG. 2. The mobile search station 50 includes a display 52 to allow the user to interact with the search interface 14. In the example of FIG. 2, the search interface 14 includes a search identifier 54 that indicates the mobile search station 50 amongst the other mobile search stations 12 in the search effort. The search identifier 54 can identify the mobile search station 50 in a variety of ways, such as by contact information, name, vehicle, or a variety of other ways to identify the mobile search station 50 to the controller station 16 and/or to the other mobile search stations 12. The search interface 14 also includes a navigation map 56 that is displayed on the display 52. As an example, the navigation map 56 can be associated with existing navigation software of the wireless electronic device that constitutes the mobile search station 50, such that, when executed, the search interface 14 can access the navigation software and/or features of the navigation software to assist in the search capability and the generation of the search data.

In the example of FIG. 2, the navigation map 56 includes a present location 58 of the mobile search station 50, which can be provided in a variety of ways (e.g., centered, overhead, birds-eye viewing, providing facing, etc.). The navigation map 56 also demonstrates a sight distance indicator 60 on the navigation map 56 that can correspond to a line-of-sight (LOS) of the user as the user traverses through the geographic region. As an example, the sight distance indicator 60 can depend on an LOS based visually of the user or of a given sensor being used, which can include the mobile search station 50, and can be automatically adjusted based on an elevation of the mobile search station 50 and/or terrain in which the mobile search station 50 is located. The search interface 14 can also include an input prompt 62 for manually adjusting the sight distance indicator 60, such as based on environment. For example, elevation of an associated vehicle (e.g., of an aircraft or of an automobile on a cliff-side road) can affect the LOS distance of the user, and thus can change the sight distance indicator 60. The sight distance indicator 60 can correspond to a portion of the geographic search area over time as the mobile search station 50 traverses the geographic region (e.g., a width of the search area), and thus can correspond to a portion of the search data that is transmitted to the controller station 16 over the network.

The geographic search area of the mobile search station 50, as provided in the search data and superimposed onto the map of the geographic region that is displayed on the monitor 18 of the controller station 16 can be based on the variable sight distance indicator 60. As one example, the real-time location of the mobile search station 50 and the associated sight distance indicator 60 can be periodically transmitted as the search data to the controller station 16 to provide the histogram for determining the geographic search area. Alternatively or additionally, the mobile search station 50 can calculate the histogram of the real-time location of the mobile search station 50 and the associated sight distance indicator 60, such that the histogram can be transmitted to the controller station 16 as the search data.

The search interface 14 also includes additional controls related to the search effort. In the example of FIG. 2, the search interface 14 includes a disengage search button 64, a visual alarm button 66, an audial alarm button 68, and an emergency response request button 70. The disengage search button 64 can correspond to a toggle for de-registration and re-registration of the mobile search station 50 with the controller station 16. The visual and audial alarm buttons 66 and 68 can correspond to contact with the search subject to provide a found condition to the controller station 16. For example, the visual alarm button 66 can allow an indication of a positive identification of the search subject, such as within the sight distance indicator 60 or in a specific location via interface with the navigation map 56. As another example, the audial alarm button 68 can allow an indication of the user of the mobile search station 50 having heard the search subject (e.g., a distress call or other audial indication), and thus provides an indication of the search subject being in proximity of the mobile search station 50. The visual and audial alarm buttons 66 and 68 can thus communicate a location indication to the controller station 16, such as part of the search data. Thus, the controller station 16 can superimpose the location indication on the map of the geographic region, which can also be transmitted to the other mobile search stations 12 in the search. Furthermore, the emergency response request button 70 can allow the user of the mobile search station 50 to request emergency services (e.g., an ambulance) in addition to the location indication. In response, the controller station 16 can immediately request the appropriate emergency services, and can provide the corresponding location of where the emergency services are required based on the search data transmitted by the mobile search station 50.

As one example, the mobile search station 50 can search the geographic region and transmit the search data to the controller station 16 based on the whims or hunches of the user of the mobile search station 50. In the example of FIG. 2, the navigation map 56 demonstrates the map of the real-time location of the mobile search station 50 in the geographic region, and thus allows the user to traverse through the geographic region without navigation instructions. As another example, the navigation map 56 can be implemented to provide navigation instructions to the user of the mobile search station 50 to travel to certain locations in the geographic region, such as in response to search commands transmitted to the mobile search station 50 by the controller station 16 via the network.

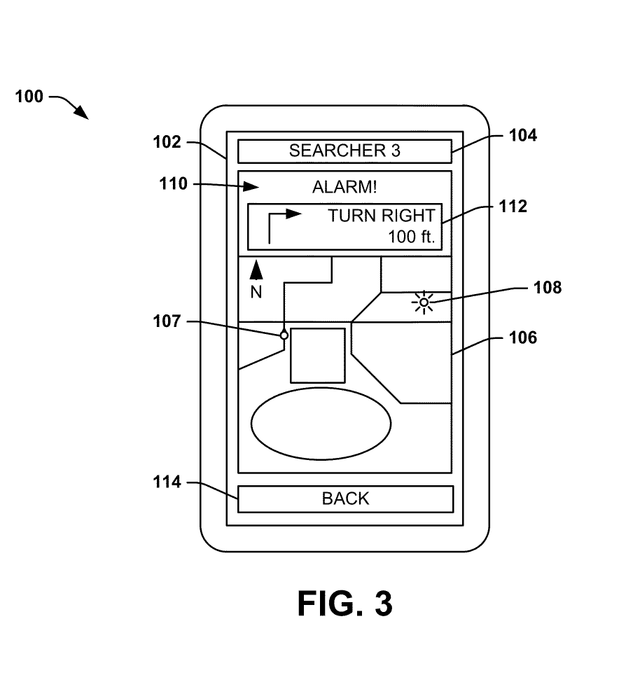

FIG. 3 illustrates another example of a mobile search station 100. The mobile search station 100 can correspond to one of the mobile search stations 12 in the example of FIG. 1 and/or the mobile search station 50 in the example of FIG. 2. Therefore, reference is to be made to the example of FIGS. 1 and 2 in the following description of the examples of FIG. 3.

The mobile search station 100 can be operating a search interface 14 (e.g., the search interface 14 in the example of FIG. 1) that can be configured as an application software program (i.e., “App”) to provide the search capability in the example of FIG. 3. The mobile search station 100 includes a display 102 to allow the user to interact with the search interface 14. In the example of FIG. 3, the search interface 14 includes a search identifier 104 that indicates the mobile search station 100 amongst the other mobile search stations 12 in the search effort. Similar to as described previously, the search identifier 104 can identify the mobile search station 100 in a variety of ways. The search interface 14 also includes a navigation map 106 that is displayed on the display 102. As an example, the navigation map 106 can be associated with existing navigation software of the wireless electronic device that constitutes the mobile search station 100, such that, when executed, the search interface 14 can access the navigation software and/or features of the navigation software to assist in the search capability and the generation of the search data.

In the example of FIG. 3, the navigation map 106 provides navigation instructions to the user to instruct the user to travel from a present location 107 to a designated location of interest 108 on the navigation map 106. As an example, the designated location of interest 108 can correspond to a location designated by the controller station 16 via the dispatch controls 20. As another example, the designated location of interest 108 can correspond to a potential location indication of the search subject, such as based on an input provided by another one of the mobile search stations 12 (e.g., via one of the visual and audial alarm buttons 66 and 68). In the example of FIG. 3, the display 102 can also provide an alarm indication 110, such as to provide a reason for the navigation instructions (e.g., in response to the search command provided by the controller station 16). The search interface 14 thus provides text navigation instructions 112 that are displayed on the display 102 along with the navigation map 106. As an example, the text navigation instructions 112 can also include an audio component to facilitate safe driving. Therefore, the user of the mobile search station 100 can be prompted to travel to the designated location of interest 108. The search interface 14 of the mobile search station 100 also includes a back button 114 to allow the user to return to other controls, such as those demonstrated on the mobile search station 50 in the example of FIG. 2. Alternatively, the other controls can be provided on the display 102 along with the navigation map 106 and the text navigation instructions 112.

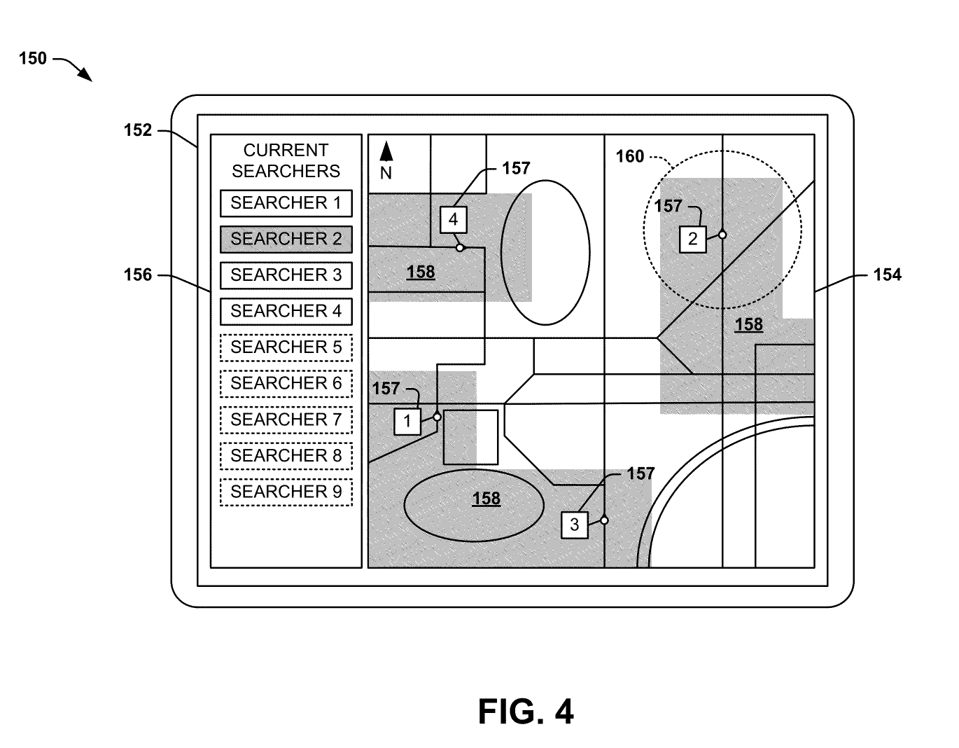

FIG. 4 illustrates an example of a controller station 150. The controller station 150 can correspond to the controller station 16 in the example of FIG. 1. Therefore, reference is to be made to the example of FIG. 1 in the following description of the example of FIG. 4. As an example, the controller station 150 can be a computer station, such as a fixed computer terminal or a wireless electronic device (e.g., a smart-phone, a laptop computer, or a tablet computer).

The controller station 150 includes a monitor 152 that can correspond to the monitor 18. The monitor 152 is demonstrated as displaying a map 154 of a geographic region, such as based on map or navigation software, and a list of current searchers 156 corresponding to mobile search stations 12 that are contributing to the search effort. In the example of FIG. 4, the list of current searchers 156 identifies four mobile search stations 12, demonstrated as SEARCHER 1 through SEARCHER 4, that are active in the current search effort (e.g., based on having a solid border in the list of current searchers 156 in the example of FIG. 4). Additionally, the list of current searchers 156 identifies five mobile search stations 12, demonstrated as SEARCHER 5 through SEARCHER 9, that are inactive in the current search effort (e.g., based on having a dashed border in the list of current searchers 156 in the example of FIG. 4). Thus, the list of current searchers 156 can provide an indication of searchers that are both active and inactive in the current search effort, and can allow a user to interact with them differently and individually.

As an example, a user of the controller station 150 can select one or more of the mobile search stations 12 in the list of the current searchers 156 (e.g., via touch, keyboard, or mouse input) to interact with the one or more mobile search stations 12. For example, an inactive one of the mobile search stations 12 can be selected to request to join the search effort or to determine a present location to determine if joining the search effort is feasible. As another example, an active one of the mobile search stations 12 can be selected to provide search commands and/or communication (e.g., voice, image, or text), such as via the dispatch controls 20. Thus, the user of the controller station 150 can interact with the mobile search stations 12 to coordinate the search effort and/or to provide commands. The communication with the mobile search stations 12, active and/or inactive, can thus be provided individually, or in a multicast/broadcast manner.

The map 154 is demonstrated in the example of FIG. 4 as including the map of the geographic region with the real-time locations of the active mobile search stations 12 superimposed thereon. The locations of the active mobile search stations 12 can also include additional information regarding the active mobile search stations 12, such as heading and/or tags that provide information or identification of the active mobile search stations 12. In the example of FIG. 4, the active mobile search stations 12 are demonstrated as including tags 157 numbering 1 through 4 to correspond to the active mobile search stations 12 in the list of current searchers 156. In addition, the map 154 demonstrates an aggregate geographic search area 158 superimposed over the map of the geographic region. The aggregate geographic search area 158 corresponds to an aggregation of the individual geographic search areas of all the active mobile search stations 12. For example, the controller station 150 can receive the search data transmitted from each of the active mobile search stations 12 via the network, and can aggregate the individual geographic search areas provided in the respective search data to generate the aggregate geographic search area 158. Therefore, the map 154 can demonstrate portions of the geographic region that have already been searched to provide for a more efficient search strategy of the geographic region, and to provide an indication of the portions of the geographic region that have yet to be searched.

In addition, in the example of FIG. 4, the controller station 150 indicates an alarm condition 160. The alarm condition 160 can have been provided as part of the search data transmitted to the controller station 150 via the network by a given one of the mobile search stations 12, demonstrated as SEARCHER 2 in the example of FIG. 4, and can correspond to any of a variety of alarms (e.g., a location indication provided via one of the visual and audial alarm buttons 66 and 68. In response, the controller station 150 can superimpose the alarm condition 160 on the map 154, such as to provide visibility of it to the user of the controller station 150. The controller station 150 can also provide an indication of which of the mobile search stations 12 provided the alarm on the list of current searchers 156, such as by causing the respective one of the mobile search stations 12 in the list of current searchers 156 to blink or change color. Additionally, the controller station 150 can be configured to transmit the alarm condition 160 to the other mobile search stations 12 and/or to the lurker stations 26, such as to provide the capability for display of the alarm condition 160 on maps and/or navigation software interfaces of the respective other mobile search stations 12 and/or lurker stations 26.

While the controller station 150 is described in the example of FIG. 4 as providing capability for interaction with the mobile search stations 12, it is to be understood that the example of FIG. 4 could also correspond to a lurker station 26. For example, a given one of the lurker stations 26 could also include the monitor 152 that displays the map 154 of the geographic region, such as based on map or navigation software, and the list of current searchers 156 corresponding to mobile search stations 12 that are contributing to the search effort. The map 154 of the lurker station 26 could also include the map of the geographic region with the real-time locations of the active mobile search stations 12 and the aggregate geographic search area 158 superimposed over the map of the geographic region. The lurker station 26 could, for example, be prohibited from providing search commands and/or interacting with the mobile search stations 12.

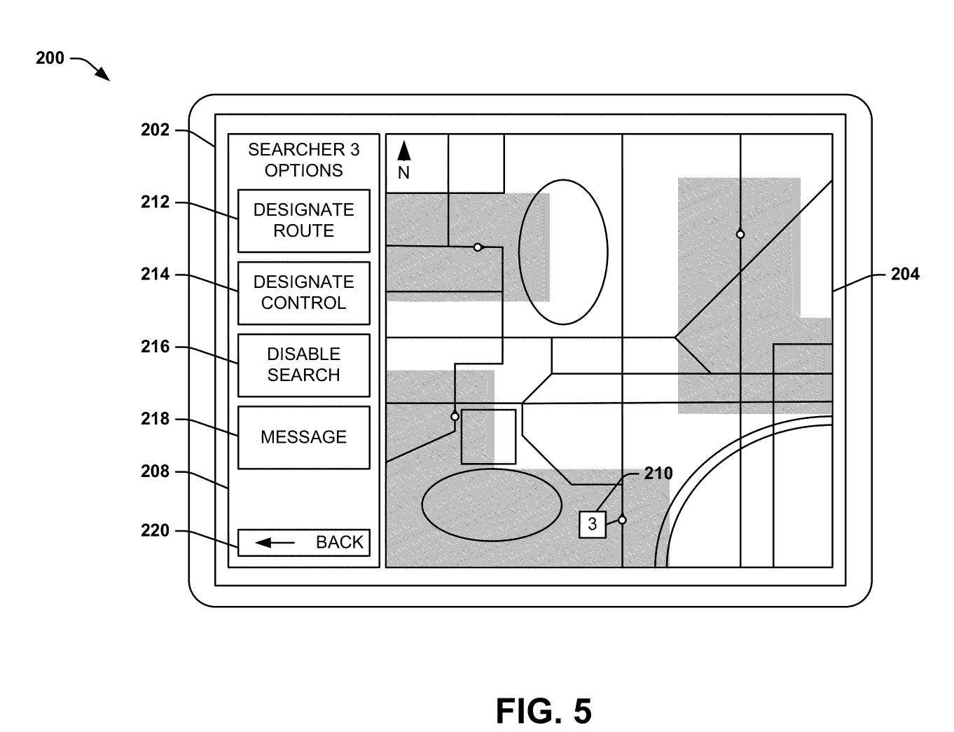

FIG. 5 illustrates another example of a controller station 200. The controller station 200 can correspond to the controller station 16 in the example of FIG. 1 and/or the controller station 150 in the example of FIG. 4. Therefore, reference is to be made to the examples of FIGS. 1 and 4 in the following description of the example of FIG. 5. As an example, the controller station 200 can be a computer station, such as a fixed computer terminal or a wireless electronic device (e.g., a smart-phone, a laptop computer, or a tablet computer).

The controller station 200 includes a monitor 202 that can correspond to the monitor 18. Similar to as described previously in the example of FIG. 4, the monitor 202 is demonstrated as displaying a map 204 of the geographic region with the real-time locations of the active mobile search stations 12 and an aggregate geographic search area 206 superimposed over the map of the geographic region. The monitor 202 also displays an options menu 208 for interacting with a given one of the mobile search stations 12, demonstrated as SEARCHER 3 in the example of FIG. 5. For example, the options menu 208 can correspond to the dispatch controls 20 in the example of FIG. 1. As an example, the user of the controller station 200 can have selected SEARCHER 3 from the list of current searchers 156 that is demonstrated in the example of FIG. 4 to access the options menu 208. The map 204 demonstrates only a tag 210 for SEARCHER 3 to highlight the geographic location of SEARCHER 3, but could instead continue to show the tags of the other active mobile search stations 12.

The options menu 208 includes a designate route button 212, a designate control button 214, a disable search button 216, and a message button 218. The designate route button 212 can be implemented to provide a search command to the selected one of the mobile search stations 12 (e.g., SEARCHER 3). Thus, the search command can be transmitted to the selected one of the mobile search stations 12 to provide navigation instructions to the selected one of the mobile search stations 12 to travel to a selected location, such as demonstrated in the example of FIG. 3. As an example, the user of the controller station 200 can designate the selected location via the map 204. The designate control button 214 can be implemented to pass control capability to the selected one of the mobile search stations 12, such as to enable the selected one of the mobile search stations 12 to become the controller station. The disable search button 216 can deactivate the selected one of the mobile search stations 12 from the current search effort, and can act as a toggle to subsequently request that the selected one of the mobile search stations 12 to re-register with the controller station 200 or return to active searching. The message button 218 can be implemented to provide messaging between the selected one of the mobile search stations 12 and the controller station 200, such as voice, picture, and/or text data. Lastly, the options menu 208 includes a back button 220 to allow the user to return to an overall control menu, such as to return to the list of current searchers 156 in the example of FIG. 4.

Therefore, as described herein, the geographic search system 10 described herein provides a manner in which the mobile search stations 12 and the controller station 16 coordinate to provide efficient and effective geographic search, such as in a search and rescue operation. As described herein, based on the transmission of the search data from each of the mobile search stations 12 to the controller station 16, and based on the aggregation of the geographic search area provided in each set of the search data to provide the aggregate geographic search area, the controller station 16 can control and coordinate the search effort among the mobile search stations 12 to provide an efficient and directed search with respect to communication with the mobile search stations 12 and to mitigate redundant searching of the geographic region of a given one of the mobile search stations 12 with respect to other mobile search stations 12. While the examples of FIGS. 2-5 demonstrate the map of the geographic area as a land/street environment, it is to be understood that the geographic search system 10 can be implemented in any of a variety of environments, such as for aquatic, underground, or in wilderness environments.

Certain embodiments of the invention are disclosed herein with reference to flowchart illustrations of methods, systems, and computer program products. It can be understood that blocks of the illustrations, and combinations of blocks in the illustrations, can be implemented by computer-executable instructions. These computer-executable instructions may be provided to one or more processor of a general purpose computer, special purpose computer, or other programmable data processing apparatus (or a combination of devices and circuits) to produce a machine, such that the instructions, which execute via the processor, implement the functions specified in the block or blocks.

These computer-executable instructions may also be stored in a non-transitory computer-readable medium that can direct a computer or other programmable data processing apparatus (e.g., one or more processing cores) to function in a particular manner, such that the instructions stored in the computer-readable medium result in an article of manufacture including instructions which implement the function specified in the flowchart block or blocks. The computer program instructions may also be loaded onto a computer (e.g., a desktop computer, a smart phone, a tablet computer, etc.) or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks or the associated description.

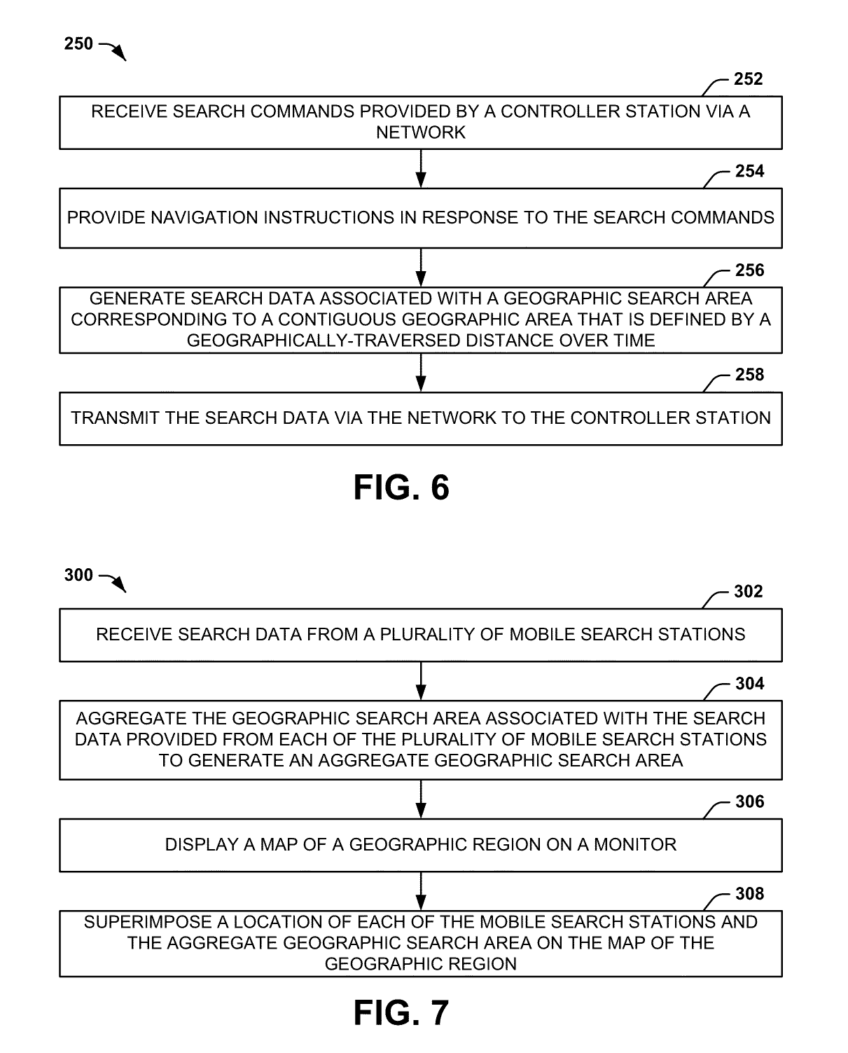

FIG. 6 illustrates an example of a method 250 for implementing a geographic search. At 252, search commands provided by a controller station (e.g., the controller station 16) are received via a network. At 254, navigation instructions are provided in response to the search commands. At 256, search data associated with a geographic search area corresponding to a contiguous geographic area that is defined by a geographically-traversed distance over time is generated. At 258, the search data is transmitted via the network to the controller station.

FIG. 7 illustrates another example of a method 300 for implementing a geographic search. At 302, search data is received from a plurality of mobile search stations (e.g., the mobile search stations 12). The search data can be associated with a geographic search area corresponding to a contiguous geographic area through which a respective one of the plurality of mobile search stations has traversed over time. At 304, the search data from each of the plurality of mobile search stations to generate an aggregate geographic search area (e.g., the aggregate geographic search area 158). At 306, a map (e.g., the map 154) of a geographic region is displayed on a monitor (e.g., the monitor 18). At 308, a location of each of the mobile search stations and the aggregate geographic search area is superimposed on the map of the geographic region.

What is disclosed herein are examples. It is, of course, not possible to describe every conceivable combination of components or methods, but one of ordinary skill in the art can recognize that many further combinations and permutations are possible. Accordingly, the disclosure is intended to embrace all such alterations, modifications, and variations that fall within the scope of this application, including the appended claims. As used herein, the term “includes” means includes but not limited to, the term “including” means including but not limited to. The term “based on” means based at least in part on. Additionally, where the disclosure or claims recite “a,” “an,” “a first,” or “another” element, or the equivalent thereof, it should be interpreted to include one or more than one such element, neither requiring nor excluding two or more such elements.

What is claimed is:

1. A method for implementing a geographic search, the method comprising:
receiving search data from a plurality of mobile search stations, the search data being associated with a geographic search area corresponding to a contiguous geographic area through which a respective one of the plurality of mobile search stations has traversed over time;
aggregating the geographic search area associated with the search data provided from each of the plurality of mobile search stations to generate an aggregate geographic search area;
displaying a map of a geographic region on a monitor; and
superimposing a geographic location of each of the mobile search stations and the aggregate geographic search area on the map of the geographic region.

2. The method of claim 1, further comprising transmitting search commands individually to the plurality of mobile search stations via the network.

3. The method of claim 1, further comprising transmitting the map of the geographic region with the geographic location of each of the mobile search stations and the geographic search area associated with the aggregate set of search data via the network to at least one of a lurker station and one of the plurality of the mobile search stations.

4. The method of claim 1, further comprising designating at least one of the one or more mobile search stations as a sub-controller station with respect to a proper subset of the one or more mobile search stations, such that the sub-controller station is configured to display the map of the geographic region and to receive the search data from each of the proper subset of the one or more mobile search stations via the network and to superimpose the physical location and the geographic search area associated with each of the proper subset of the one or more mobile search stations on the map of the geographic region.

5. The method of claim 1, further comprising:
receiving at least one of a visual alarm and an audial alarm provided by a respective one of the mobile search stations; and
superimposing a geographic indicator of a found condition on the map of the geographic region in response to the at least one of the visual alarm and the audial alarm provided by the respective one of the mobile search stations.

6. The method of claim 5, further comprising transmitting the map of the geographic region with the geographic indicator of the found condition via the network to at least one of a lurker station and one of the plurality of the mobile search stations.

7. The method of claim 5, further comprising:
receiving a request for a request for emergency services in addition to the at least one of the visual alarm and the audial alarm provided by the respective one of the mobile search stations; and
contacting and directing emergency services to a geographic location associated with the geographic indicator of the found condition.

8. A method for implementing a geographic search, the method comprising:
receiving search commands provided by a controller station via a network;
providing navigation instructions in response to the search commands;
generating search data associated with a geographic search area corresponding to a contiguous geographic area that is defined by a geographically-traversed distance over time; and
transmitting the search data via the network to the controller station.

9. The method of claim 8, further comprising prompting at least one of a visual alarm and an audial alarm that is included in the search data, the at least one of the visual alarm and the audial alarm indicating a location indication in the geographic search area.

10. The method of claim 8, further comprising prompting a request for emergency services in the search data.

11. The method of claim 8, wherein providing the navigation instructions comprises providing the navigation instructions via navigation software configured to provide navigation assistance to an associated user, wherein generating the search data comprises generating the search data via the navigation software and location-based services.

12. The method of claim 8, further comprising prompting a variable sight distance input allow a user to set a variable sight distance corresponding to the geographic search area.

13. A geographic search system comprising:
one or more mobile search stations that are each configured to generate search data associated with a geographic search area corresponding to a contiguous geographic area through which a respective one of the one or more mobile search stations has traversed over time; and
a controller station comprising a monitor configured to display a map of a geographic region, the controller station being configured to receive the search data from each of the one or more mobile search stations via a network and to superimpose a physical location and the geographic search area associated with each of the one or more mobile search stations on the map of the geographic region.

14. The system of claim 13, wherein each of the one or more mobile search stations comprises navigation software configured to provide navigation assistance to a user in response to search commands provided by the controller station to the respective one of the one or more mobile search stations via the network.

15. The system of claim 13, wherein each of the one or more mobile search stations is configured as a wireless electronic device configured to implement an application software program to generate the search data via location-based services associated with the wireless electronic device.

16. The system of claim 15, wherein the controller station is configured to selectively register the one or more mobile search stations to receive the search data from each respective one of the respective one or more mobile search stations based on contact information associated with the respective wireless electronic device.

17. The system of claim 15, wherein the application software program is configured to implement navigation software associated with the respective wireless electronic device with the location-based services to generate the search data.

18. The system of claim 17, wherein the controller station comprises dispatch controls configured to provide search commands individually to the one or more mobile search stations, wherein at least one of the search commands is provided on the navigation software associated with the respective wireless electronic device.

19. The system of claim 13, further comprising at least one lurker station comprising a lurker monitor and configured to receive lurker data from the controller station via the network, the lurker station being configured to display the map of the geographic region with the superimposed physical location and the geographic search area associated with each of the one or more mobile search stations on the monitor.

20. The system of claim 13, wherein the controller station is configured to designate at least one of the one or more mobile search stations as a sub-controller station with respect to a proper subset of the one or more mobile search stations, such that the sub-controller station is configured to display the map of the geographic region and to receive the search data from each of the proper subset of the one or more mobile search stations via the network and to superimpose the physical location and the geographic search area associated with each of the proper subset of the one or more mobile search stations on the map of the geographic region.
